(19) United States
(12) Patent Application Publication
(10) Pub. No.: US 2003/0099213 A1
(43) Pub. Date: May 29, 2003

(54) Wireless radio data protective device for private/public network wireless packet data services and authentication method according to internet connection request of mobile terminals receiving the services

(76) Inventors: Gui-Jung Lee, Yongin-shi (KR); Tae-Young Kil, Seoul (KR)

Correspondence Address: Robert E. Bushnell, Suite 300, 1522 K Street, N.W., Washington, DC, 20005, US

(21) Appl. No.: 10/298,636

(22) Filed: Nov. 19, 2002

(30) Foreign Application Priority Data
Nov. 29, 2001 (KR) 2001-75116

(51) Int. Cl. H04Q 7/00

(52) U.S. Cl. 370/328; 370/338

(57) ABSTRACT

A wireless data protective device in a communication system for providing private/public network wireless packet data services includes: intranet connected to the Internet through a firewall system; and private base station controller, mounted with a packet data processor for doing wireless data communication with a mobile terminal through private or public base station, and for enabling the terminal to exchange packet data through the intranet. In addition, an authentication method at a request of the mobile terminal for Internet connection in the communication system, mounted with the wireless data protective device, for providing private/public network wireless packet data services includes: (1) the mobile terminal transmits a link control protocol (hereinafter, it is referred to LCP)_generate_request signal to the packet data processor; (2) the packet data processor transmits a LCP_Config_Ack signal, and a LCP_Config_Request signal to the mobile terminal; and (3) the mobile terminal transmits a LCP_Config_Ack signal to the packet data processor.

### CLAIM OF PRIORITY

This application makes reference to, incorporates the same herein, and claims all benefits accruing under 35 U.S.C. §119 from an application for WIRELESS DATA SECURITY APPARATUS FOR PRIVATE/PUBLIC PACKET DATA SERVICE AND AUTHENTICATION METHOD ACCORDING TO INTERNET CONNECTION REQUEST OF MOBILE TERMINAL earlier filed in the Korean Industrial Property Office on Nov. 29, 2001 and there duly assigned Ser. No. 2001-75116.

### BACKGROUND OF THE INVENTION

1. Field of the Invention

The present invention relates generally to code division multiple access (hereinafter, it is abbreviated to CDMA) systems. In particular, the present invention relates to a wireless radio data protective device for private/public network wireless packet data services and authentication method according to Internet connection request of mobile terminals receiving the services.

2. Description of the Related Art

Intranet is a computer network applying Internet technologies for the exclusive use of a company, and more specifically, an Internet within the company for sharing every standardized information about the business through a server. Not only for the construction of such intranet, but also for the development of e-commerce (electronic-commerce) and e-business (electronic-business), wireless Internet has been expanding rapidly. Unfortunately though, the wireless Internet also brought problems like security and authentication.

Usually, security over a cable network has been maintained using a firewall system or monitoring method. However, there is no proper way to protect data sharing through wireless network to date.

Although wireless data communication over the public network can freely access to Internet, the Internet access within in-plant or general businesses is not that easy. In other words, company security policy usually blocks any access from the outside to intranet, using a firewall system, and some companies even block access to the outside. Therefore, the known authentication method applied to public network is not that effective to block any illegal access to the intranet. In short, the security system used in company cable network cannot guarantee the best security.

### SUMMARY OF THE INVENTION

It is, therefore, an object of the present invention to provide a wireless radio data protective device for private/public network wireless packet data services and authentication method according to Internet connection request of mobile terminals receiving the services, which is capable of establishing a security system comparable to other general cable work security systems by blocking any illegal leakage of company information by an insider or an outsider.

To achieve the above and other objects, there is provided a wireless data protective device for use of communication systems providing private and public network wireless packet data services, which includes: intranet connected to Internet through a firewall system; and private base station controller, mounted with a packet data processor for doing wireless data communication with a mobile terminal through private or public base station, and for enabling the terminal to exchange packet data through the intranet.

In another aspect of the present invention, there is provided an authentication method at the request of the terminal to access to Internet in the communication system mounted with the wireless data protective device, providing private and public network wireless packet data services, the method including the following steps: (1) the mobile terminal transmits a LCP_Config_Request signal to the packet data processor; (2) the packet data processor transmits a LCP_Config_Ack signal, and a LCP_Config_Request signal to the mobile terminal; and (3) the mobile terminal transmits the LCP_Config_Ack signal to the packet data processor.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic diagram of an Internet connectable wireless data communication system;

FIG. 2 is a flow chart illustrating the procedure of terminal authentication in the Internet connectable wireless data communication system;

FIG. 3 is a schematic diagram of a communication system mounted with a wireless data protective device for private/public network wireless packet data services in accordance with a preferred embodiment of the present invention;

FIG. 4 diagrammatically shows a detailed configuration of a communication system mounted with a wireless data protective device for private/public network wireless packet data services in accordance with a preferred embodiment of the present invention;

FIG. 5 illustrates structure of a private base station controller shown in FIG. 4;

FIG. 6 is a schematic diagram of pRPP shown in FIG. 4; and

FIG. 7 is a flow chart illustrating an authentication procedure in accordance with the preferred embodiment of the present invention. at a request of a mobile terminal provided with private/public network wireless packet data services to access to Internet.

### DETAILED DESCRIPTION OF THE PREFERRED EMBODIMENTS

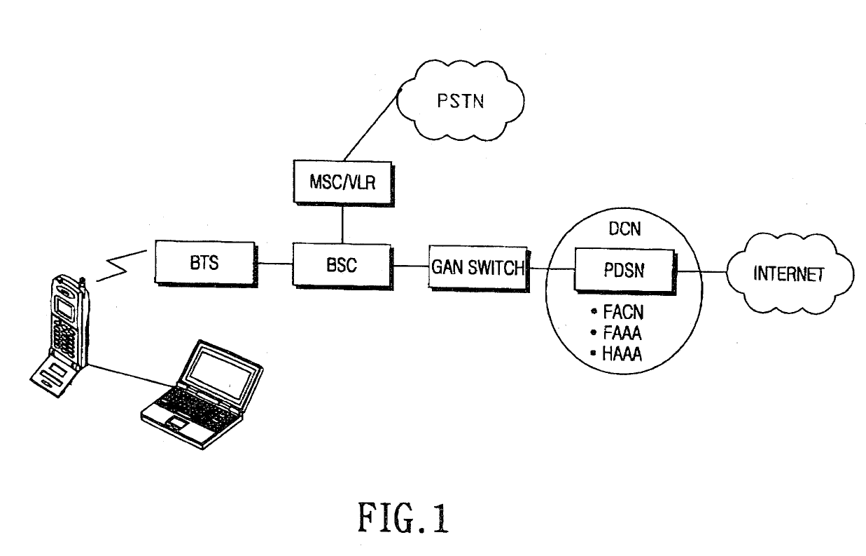

FIG. 1 is a schematic diagram of an Internet connectable wireless data communication system.

Data network architecture of CDMA-2000 is largely divided into radio access network (hereinafter, it is referred to as RAN), voice core network (hereinafter, it is referred to as VCN), and data core network (hereinafter, it is referred to as DCN).

RAN is composed of base transceiver station (hereinafter, it is referred to as BTS), base station controller (hereinafter, it is referred to as BSC), and global area network (hereinafter, it is referred to as GAN), and it transfers voice and data to the VCN and the DCN. VCN is mounted with MSC (mobile switching center) and home location register (hereinafter, it is referred to as HLR), and it provides voice services. The DCN includes packet data serving node (hereinafter, it is referred to as PDSN), home agent, AAA server (authentication, authorization, and accounting server) for providing security services, and network management system (hereinafter, it is referred to as NMS), and it provides packet services.

Circuit data/packet data network security is divided into an authentication part and data encryption part. Particularly, CDMA-2000 system security is divided into terminal authentication, simple IP (Internet protocol) user authentication, mobile IP (Internet Protocol) user authentication, and authentication between network elements (NE).

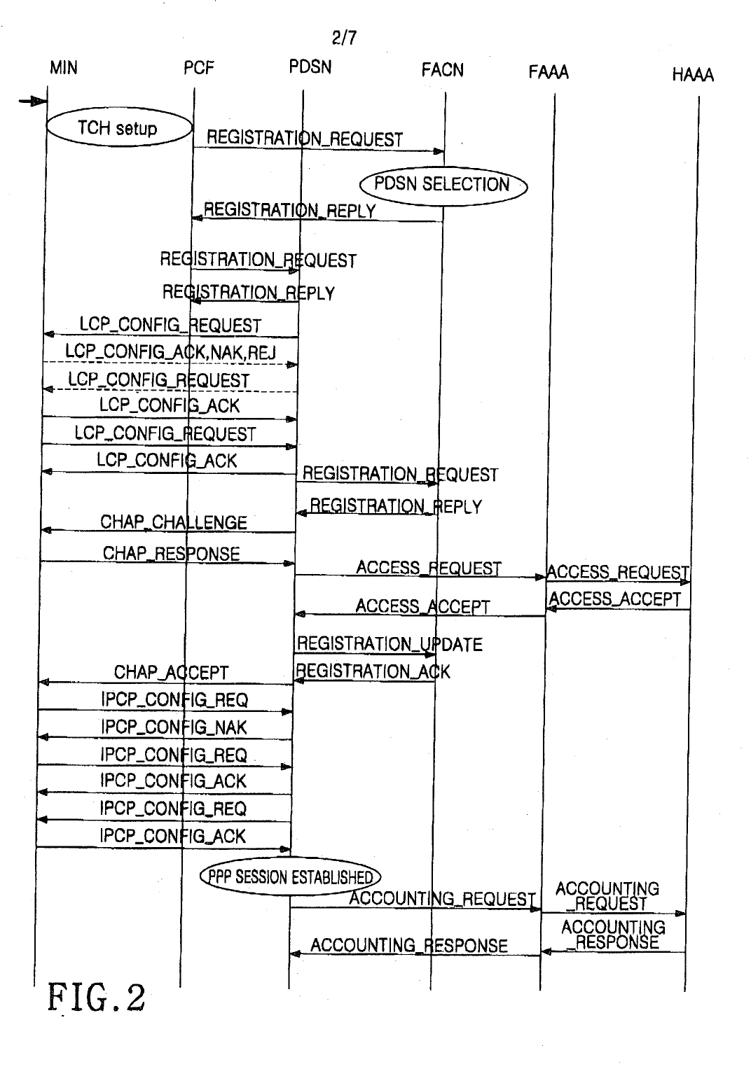

FIG. 2 is a flow chart illustrating the procedure of terminal authentication in the Internet connectable wireless data communication system.

CDMA-2000 packet data network security is divided into the authentication part and authorization part.

To explain the terminal authentication first, it is done between MSC/HLR and a terminal when packet data call is designated. In order to shorten the time spent in designating the packet data call, and to avoid any redundant authentication, some businessmen might not need the terminal authentication function.

On the other hand, as for user authentication, when simple IP data session is designated, user authentication uses point to point protocol (hereinafter, it is referred to PPP) authentication function. PPP negotiation procedure is largely divided into LCP phase, authentication phase, and Internet protocol control protocol (hereinafter, it is referred to IPCP) phase, and the authentication method is negotiated in the LCP phase. At this time, depending on the negotiated authentication method, authentication is done at the authentication phase. PDSN suggests several authentication methods, such as, CHAP (challenge-handshake authentication protocol), PAP (password authentication protocol), or EAP (E authentication protocol), and the terminal selects one of them. User password and CHAP key are stored in the AAA server. Therefore, the PDSN sends authentication information from the terminal to AAA server. Then, the AAA server authenticates the information in conforming to the predetermined authentication algorithm, and notifies the result to the PDSN. Depending on the authentication result sent from the AAA server, PDSN either continues PPP negotiation or discontinues PPP negotiation and disconnects. Even when the terminal rejects all authentication methods, PDSN could allow the terminal to access to Internet anyway. In such a case, PDSN generates NAI (network access identifier) using IMSI (international mobile station identity) number of the terminal. Based on the NAI generated, PDSN creates accounting information.

Authentication method negotiation for simple IP service users is now explained.

Authentication of simple IP service users is either CHAP or PAP. Usually, the negotiation is made at the LCP (i.e., “link control protocol”) phase of PPP protocol as follows. First, PDSN creates a LCP_Config_Request (i.e., “LCP configure request” or “LCP configuration request”) signal suggesting CHAP-based authentication, and sends the signal to a terminal. If the terminal wants CHAP, PDSN responds as a LCP_mode_Ack (i.e., “LCP mode acknowledgement” or “LCP mode positive acknowledgement”) signal. On the other hand, if the terminal prefers PAP-based authentication, PDSN sends a LCP_Config_Request signal to the terminal, suggesting CHAP, and the terminal responds to it as LCP_Config_Nak (i.e., “LCP configure non-acknowledgement” or “LCP configuration negative acknowledgement” or “LCP configuration negative acknowledge character”), suggesting PAP. Then, PDSN again sends the LCP_Config_Request signal, suggesting PAP, to the terminal. In response, the terminal answers as LCP_Config_Ack. If the terminal wants simple IP service without going through any type of authentication, PSDN sends the LCP_Config_Request signal, suggesting CHAP to the terminal, and the terminal answers as the LCP_Config_Nak. Later, PDSN again sends the terminal a LCP_Config_Request signal without authentication option, and the terminal replies as LCP_Config_Ack.

The following explains authentication and authorization method for simple IP server users. As described before, authentication and authorization are done at the authentication phase of PPP in conforming to the negotiated method at the LCP phase of PPP. As for authentication, if CHAP is selected, PDSN sends a CHAP challenge signal to the terminal, and the terminal responds to the CHAP. On the contrary, if PAP is chosen over CHAP, the terminal first sends PAP_Response signal to PDSN. Explained so far is the procedure necessary for authentication/authorization over PPP, and the authentication/authorization is practically done through radius protocol. Upon receiving CHAP_Response signal or PAP_Response signal from the terminal, PDSN sends the radius server an Access_Request including the following information:

User name=NAI;

User password=password (in case of PAP);

CHAP−password=CHAP ID and CHAP_Response (in case of CHAP);

NAS−IP−address=IP address of PDSN; and

Correlation ID (identification or identity).

At the request of PDSN, radius sends an Access-Accept signal to PDSN, and PDSN transfers CHAP_succeed or PAP_succeed to the terminal. In this manner, the authentication and authorization procedure is successfully completed. However, if a single attribute included in the access-request is denied, the radius sends an Access-Nak to PDSN, and PDSN transfers CHAP_fail or PAP_fail to the terminal, meaning that the authentication eventually failed. The radius packet, i.e., Access_Request, Access_Accept, Access_Nak, needed for the authentication and authorization should be exchanged using UDP (i.e., “user datagram protocol”) port 1812.

As explained so far, public network security tells that as long as a terminal is registered by passing the terminal authentication procedure only, it can access to the Internet anywhere through PDSN. The thing is though the necessary procedure for authentication and security in the public network is very complicated. One of the weak points found in such authentication and security is that it does not work for the firewall system in a company because the terminal directly accesses to IP-network through public network base station and control station via RF (radio frequency).

Although wireless data communication over the public network can freely access to Internet, the Internet access within in-plant or general businesses is not that easy. In other words, company security policy usually blocks any access from the outside to intranet, using a firewall system, and some companies even block access to the outside. Therefore, the known authentication method applied to public network is not that effective to block any illegal access to the intranet. In short, the security system used in company cable network cannot guarantee the best security.

A preferred embodiment of the present invention will be described herein below with reference to the accompanying drawings. In the following description, well-known functions or constructions are not described in detail since they would obscure the invention in unnecessary detail.

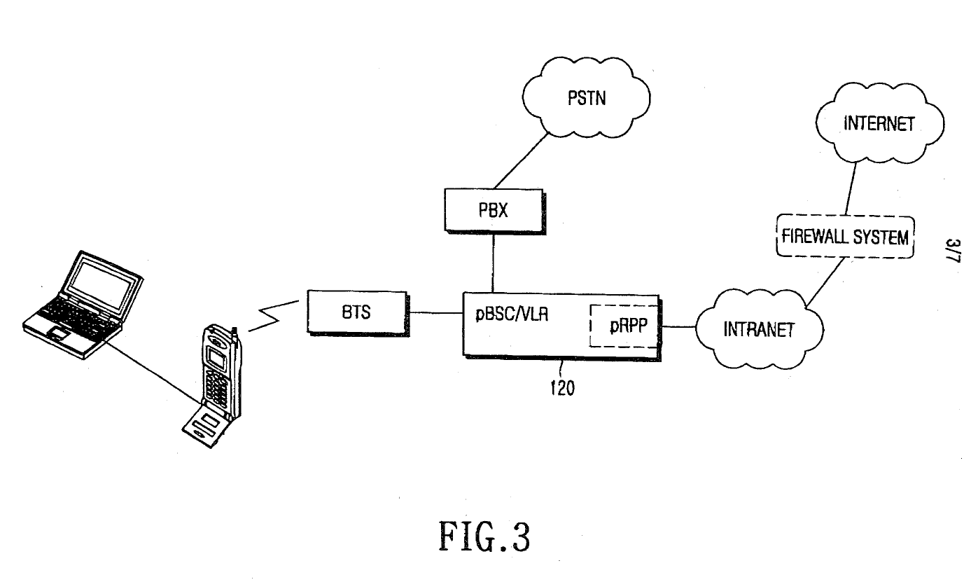

FIG. 3 is a schematic diagram of a communication system mounted with a wireless data protective device for private/public network wireless packet data services in accordance with a preferred embodiment of the present invention.

The mobile terminal connected to a notebook computer is used for both private and public network, and is connectable to an Internet network.

A private base station controller (hereinafter, it is referred to as pBSC) is connected to private base station (hereinafter, it is referred to as pBTS) or public base station (hereinafter, it is referred to BTS). pBSC 120 includes a private packet data processor (hereinafter, it is referred to as pRPP) for access to the intranet. The intranet is connected to the Internet through a firewall system, and the data, a mobile terminal user sent, is restored to a complete IP packet from the pRPP (i.e., “private Radio Packet Processor”) and the IP packet is transferred to the intranet.

pBSC 120 includes a visitor location register (hereinafter, it is referred to VLR) and a home location register (hereinafter, it is referred to as HLR) (not shown). Although not depicted in the drawing, a wireless system manager is in charge of administration and management of the pBSC and BTS.

Meanwhile, packet data call setup in the system interworks with intranet. In fact, intranet is available to the terminals that are registered to the private network as well as to the terminals that are registered to the public network, so anytime the terminal registered to the public network wants data services in the office, it can access through the intranet.

Shortly speaking, according to the present invention, when a user having a terminal that is registered to a private wireless system gets private services, the user cannot access directly to the Internet through PDSN (packet data serving node) but can access to the intranet only, thereby preventing any unexpected leakage of company information. Moreover, a general subscriber who registered to the public network can access to Internet only through the intranet in the office, thereby preventing any leakage of company information caused by an outsider.

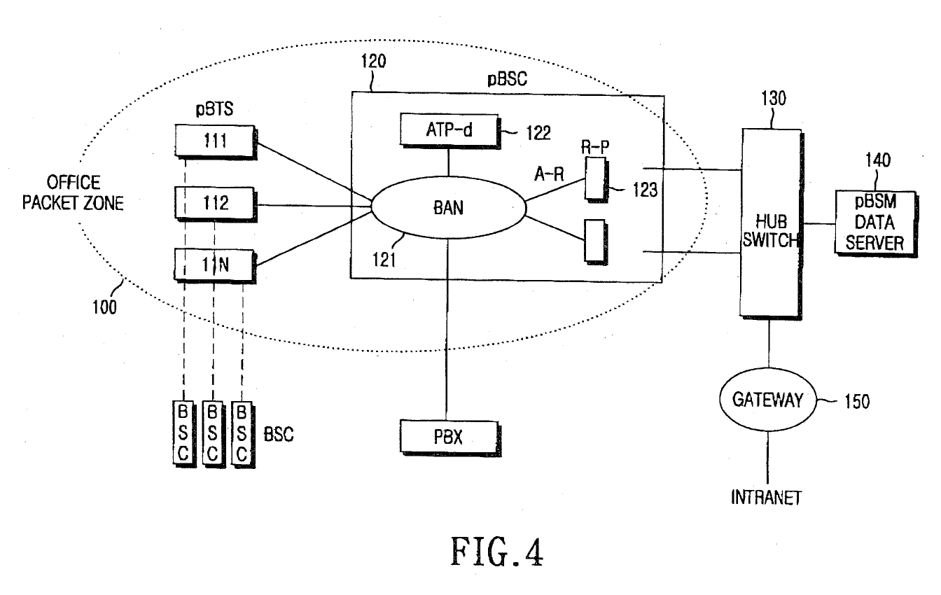

FIG. 4 is a diagram showing a detailed configuration of a communication system mounted with a wireless data protective device for private/public network wireless packet data services in accordance with a preferred embodiment of the present invention.

Office packet zone 100 is a private wireless data network, and includes private BTS (PBTS) 111-11N, and pBSC 120 for controlling communication of the private BTS 111-11N. pBSC 120 includes BAN (BSC ATM (asynchronous transfer mode) network) 121, a general name of all ATM paths inside of a base station controller BSC; ATP-d 122, a BSC hardware board on which radio link protocol (hereinafter, it is referred to RLP) software {AMC (i.e., “ATP (Air Termination Processor) MAC Control,” which is a block that is mainly in charge of traffic process on packet calls and line calls, controls the state of MAC (Media Access Channel), transmits/receives PPP frame through the interface with RPP blocks, and multiplexes (MUX)/demultiplexes (DEMUX) an air frame every 20 ms. That is, RLP is embodied in AMC software blocks)—it will de explained later} for controlling data packet flow between the mobile terminal and the system, and for retransmitting the data packet is being operated; and radio packet connection unit (RP) 123, a BSC hardware board on which a software for providing private data functions is being operated.

The pBSC 120 is connected to a hub switch 130, a switching network equipment. And the hub switch 130 is connected to pBSM (i.e., “private base station manager”) data server 140, a private BSM connected to the BAN 121, and is connected to gateway 150, a general network equipment where a packet to be transmitted to another network segment passes through. The gateway 150 is connected to the intranet.

Usually, mobile terminal users can access to the BSC to get private/public network wireless Internet services or to do radio voice communication.

When pBTS receives a transmission signal from the mobile terminal, it should find out what the mobile terminal requests, such as, whether it requests private Internet or voice communication service, or public network Internet service or voice communication service. To this end, pBTS 111˜11N divide Internet services into private and public network services using the user's dialing information that has been received from the mobile terminal. That is, pBTS 111˜11N discriminate private network services or public network services based on the dialing number received. For this discrimination, pBSC 120 does not have to have a separate database, and a packet data service through BSC and pBSC 120 is determined by using a connected line field.

The private Internet service system does not use a backbone network like an ATM switch, but distributes radio packet data through the hub switch 130. The system processes packet data by using some functions of its software inside of the pBSC 120, wherein the functions are similar to data equipment like PDSN and DCN (data core network).

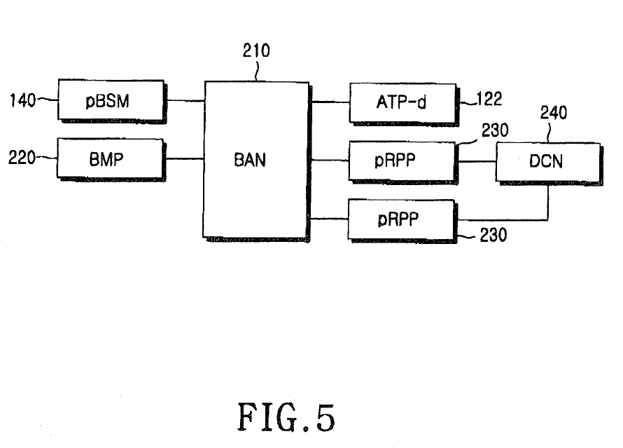

FIG. 5 is a schematic diagram of a private base station controller shown in FIG. 4.

BAN 210 is a general name of all ATM paths inside of the pBSC 120. BMP (i.e., “BSC Main Processor”) 220 is a hardware board of the BSC on which software blocks for processing radio calls are being operated. pRPP 230 is a hardware board of BSC on which software blocks for providing office data functions are being operated, performing the same functions with the radio packet connection (RP) 123. Also, DCN (data core network) 240 is a general name for all equipments connected to a general LAN network.

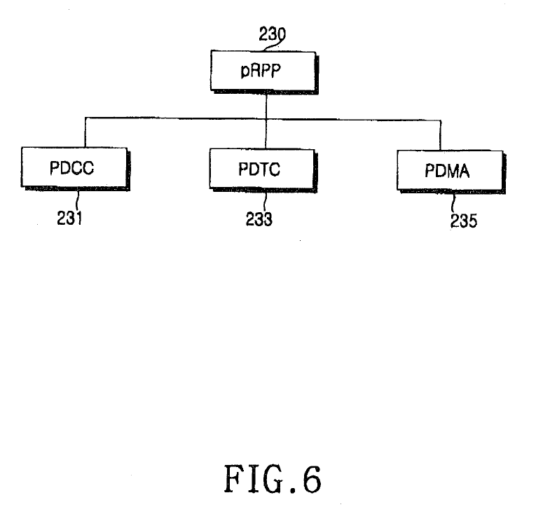

FIG. 6 is a schematic diagram of pRPP shown in FIG. 4.

PDCC module (packet data call control module) 231 is disposed between AMC and DCN 240, software blocks inside of ATP-d that are in charge of traffic process on packet calls and line calls, and generates RP (radio packet) connection (ARI (i.e., “AMC RPP Interface,” which means an interface between ATP-d and RPP), RPI (i.e., “RPP PDSN Interface,” which means an interface between RPP and PDSN)) necessary for transceiving packet data of a terminal, terminates the connection, and processes the status of a packet call. PDTC module (packet data traffic control module) 233 disposed between AMC and DCN 240 is in charge of data transceiving. PDMA module (packet data maintenance administration module) 235 works as an interface for operation & maintenance (hereinafter, it is referred to as O&M) function blocks of BAN 210. Besides interfacing the O&M function blocks, PDMA module checks the status of AMC, ATM, and PVC (i.e., “permanent virtual connection,” namely, an open ATM path beforehand), and checks the link status with the DCN 240.

pRPP 230 does the following performances. First of all, it conducts packet call control & state transition on office packet calls. Second, it conducts PPP daemon (point-to-point protocol daemon) for private wireless packet Internet services. Third, it conducts ARI flow control and PNA (packet network architecture) on the packet data. Lastly, it conducts dormant buffering & paging request, packet link register, and packet O&M.

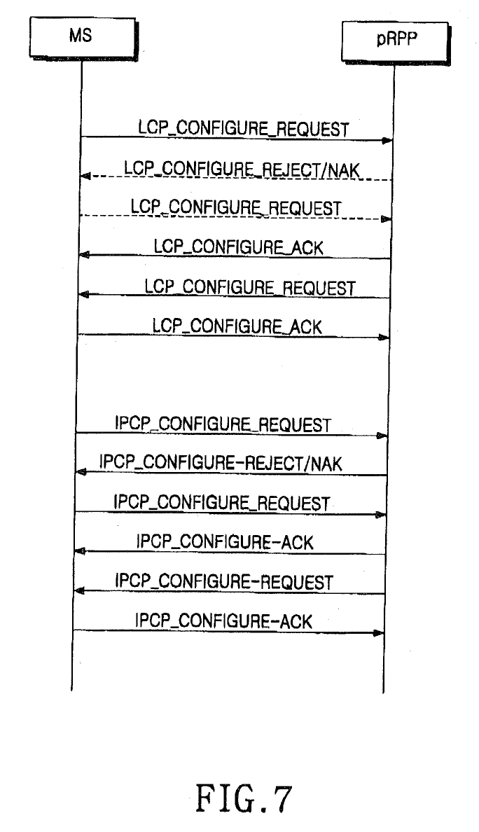

FIG. 7 is a flow chart of an authentication procedure in accordance with the preferred embodiment of the present invention at a request of a mobile terminal provided with private/public network wireless packet data services to access to the Internet.

To begin with, the mobile terminal (MS, i.e., “mobile station”) transmits an LCP_Config_Request signal to the packet data processor (pRPP) of a wireless data protective device in a communication system providing private/public network wireless packet data services. Then the packet data processor transmits a LCP_Config_Ack signal to the mobile terminal, and transmits the LCP_Config_Request signal. Lastly, the mobile terminal transmits the LCP_Config_Ack signal to the packet data processor. In this way, authentication is successfully done.

However, if the packet data processor, having been the LCP_Config_Request signal form the mobile terminal, transmits a LCP_Config_Nak signal to the mobile terminal, the mobile terminal, upon receiving the LCP_generate_Nak signal, can transmit the LCP_Config_Request signal again back to the packet data processor.

Further, the mobile terminal transmits an IPCP_Config_Req (i.e., “IPCP configure request”) signal to the packet data processor of a wireless data protective device in a communication system providing private/public network wireless packet data services. Then the packet data processor transmits an IPCP_Config_Ack signal to the mobile terminal, and transmits the IPCP_Config_Req signal. Lastly, the mobile terminal transmits the IPCP_Config_Ack signal to the packet data processor. In this way, authentication is successfully done.

However, if the packet data processor, having been the IPCP_Config_Req signal form the mobile terminal, transmits an IPCP_Config_Nak signal to the mobile terminal, the mobile terminal, upon receiving the IPCP_Config_Nak signal, can transmit the IPCP_Config_Req signal again back to the packet data processor.

In conclusion, the present invention succeeded to establish a security system comparable to other general cable network security systems by blocking any illegal leakage of company information by an insider or an outsider.

While the invention has been shown and described with reference to a certain preferred embodiment thereof, it will be understood by those skilled in the art that various changes in form and details maybe made therein without departing from the spirit and scope of the invention as defined by the appended claims.

What is claimed is:

1. A wireless data protective device for use of communication systems providing private and public network wireless packet data services, the device comprising:
an intranet connected to the Internet through a firewall unit; and
a private base station controller, mounted with a packet data processor for doing wireless data communication with a mobile terminal through private or public base station, enabling the terminal to exchange packet data through the intranet.

2. The device as claimed in claim 1, with the packet data processor including packet data call controller, packet data traffic controller, and packet data manager.

3. The device as claimed in claim 2, with the packet data call controller generating radio packet connection necessary for transceiving packet data of the terminal, terminates the connection, and processes the status of a call packet.

4. The device as claimed in claim 3, with the packet data call controller being connected to the data core network.

5. The device as claimed in claim 2, with the packet data traffic controller being in charge of data transceiving.

6. The device as claimed in claim 5, with the packet data traffic controller being connected to the data core network.

7. The device as claimed in claim 2, with the packet data manager interfacing for operation and maintenance function blocks of the private base station controller.

8. The device as claimed in claim 7, with the private base station controller further comprising a base station controller of an asynchronous transfer mode network using the packet data manager for interfacing of the operation and maintenance function blocks.

9. The device as claimed in claim 4, with the packet data traffic controller being in charge of data transceiving.

10. The device as claimed in claim 9, with the packet data manager interfacing for operation and maintenance function blocks of the private base station controller.

11. The device as claimed in claim 10, further comprising of the mobile terminal transmitting a link control protocol generate request signal to the packet data processor, the packet data processor transmitting a link control protocol configure acknowledgment signal and a link control protocol configure request signal to the mobile terminal, and the mobile terminal transmitting a link control protocol configure acknowledgment signal to the packet data processor.

12. The device as claimed in claim 11, further comprising of after receiving the link control protocol configure request signal from the mobile terminal, transmitting, at the packet data processor, a link control protocol generate negative-acknowledgment signal to the mobile terminal, and after receiving the link control protocol generate negative-acknowledgment signal from the packet data processor, transmitting, at the mobile terminal, again link control protocol configure request signal to the packet data processor.

13. An authentication method at a request of a mobile terminal for Internet connection in a private/public network wireless packet data service communication system, wherein the system is mounted with a private base station controller, having a packet data processor for doing wireless data communication with a mobile terminal through private or public base station, and for enabling the terminal to exchange packet data through intranet that is connected to the Internet through a firewall system, the method comprising the steps of:
transmitting, at the mobile terminal, a link control protocol generate request signal to the packet data processor;
transmitting, at the packet data processor, a link control protocol configure acknowledgment signal, and a link control protocol configure request signal to the mobile terminal; and
transmitting, at the mobile terminal, a link control protocol configure acknowledgment signal to the packet data processor.

14. The method as claimed in claim 13, further comprising the steps of:
after receiving the link control protocol configure request signal from the mobile terminal, transmitting, at the packet data processor, a link control protocol generate negative-acknowledgment signal to the mobile terminal; and
after receiving the link control protocol generate negative-acknowledgment signal from the packet data processor, transmitting, at the mobile terminal, again link control protocol configure request signal to the packet data processor.

15. An authentication method at a request of a mobile terminal for Internet connection in a private/public network wireless packet data service communication system, wherein the system is mounted with a private base station controller, having a packet data processor for doing wireless data communication with a mobile terminal through private or public base station, and for enabling the terminal to exchange packet data through intranet that is connected to the Internet through a firewall system, the method comprising the steps of:
transmitting, at the mobile terminal, an Internet protocol control protocol generate request signal to the packet data processor;
transmitting, at the packet data processor, an Internet protocol control protocol configure acknowledgment signal, and a link control protocol configure request signal to the mobile terminal; and
transmitting, at the mobile terminal, an Internet protocol control protocol configure acknowledgment signal to the packet data processor.

16. The method as claimed in claim 15, further comprising the steps of:
after receiving the Internet protocol control protocol configure request signal from the mobile terminal, transmitting, at the packet data processor, an Internet protocol control protocol configure negative acknowledgment signal to the mobile terminal: and
after receiving the Internet protocol control protocol configure negative-acknowledgment signal from the packet data processor, transmitting, at the mobile terminal, again an Internet protocol control protocol configure request signal to the packet data processor.

17. An authentication method at a request of a mobile terminal for Internet connection in a private and public network wireless packet data service communication system, comprising:
transmitting, at the mobile terminal, a link control protocol generate request signal to a packet data processor;
transmitting, at the packet data processor, a link control protocol configure acknowledgment signal, and a link control protocol configure request signal to the mobile terminal; and
transmitting, at the mobile terminal, a link control protocol configure acknowledgment signal to the packet data processor.

18. The method of claim 17, further comprising of enabling the terminal to exchange packet data to the Internet through an intranet and a firewall connected to the Internet.

19. The method as claimed in claim 18, further comprising:
after receiving the link control protocol configure request signal from the mobile terminal, transmitting, at the packet data processor, a link control protocol generate negative-acknowledgment signal to the mobile terminal; and
after receiving the link control protocol generate negative-acknowledgment signal from the packet data processor, transmitting, at the mobile terminal, again link control protocol configure request signal to the packet data processor.

20. The method as claimed in claim 18, further comprising:
transmitting, at the packet data processor, a link control protocol generate negative acknowledgment signal to the mobile terminal; and
transmitting, at the mobile terminal, again link control protocol configure request signal to the packet data processor.

21. The method as claimed in claim 18, further comprising:
after receiving the link control protocol configure request signal from the mobile terminal, transmitting, at the packet data processor, a link control protocol generate negative-acknowledgment signal to the mobile terminal; and
after receiving the link control protocol generate negative-acknowledgment signal from the packet data processor, transmitting again link control protocol configure request signal to the packet data processor.
